(19) United States
(12) Patent Application Publication
(10) Pub. No.: US 2026/0218866 A1
(43) Pub. Date: Jul. 30, 2026

(54) Self-Lit Footlocker Face Indicia

(71) Applicant: AIM Design, LLC, Desoto, TX (US)

(72) Inventor: Sam Allen, Maypearl, TX (US)

(73) Assignee: AIM Design, LLC, Desoto, TX (US)

(21) Appl. No.: 19/574,659

(22) Filed: Mar. 23, 2026

Related U.S. Application Data
(63) Continuation-in-part of application No. 16/731,587, filed on Dec. 31, 2019, now abandoned.

(51) Int. Cl. F21S 4/24; A47B 61/00; F21W 131/301; F21Y 115/10

(52) U.S. Cl. CPC F21S 4/24; A47B 61/00; A47B 2220/0077; F21W 2131/301; F21Y 2115/10

(57) ABSTRACT

A self-lit door for a locker includes a substrate panel having a top edge and a side edge that are generally straight and connected by a corner. A non-uniform texture is formed on an exterior of the substrate panel at a location relative to the top edge and the side edge. An edge light is positioned relative to at least one of the top edge and the side edge and is in optical communication with the substrate panel through an optical coupling interface. Light introduced through an optically functional edge surface of the substrate panel propagates internally within the substrate panel and interacts with the non-uniform texture to emit visible illumination. In some embodiments, the texture defines illuminated indicia relative to surrounding regions of the substrate panel.

This application is a continuation-in-part of U.S. Patent Application No. 16/731,587, filed 31 December 2019, titled “Self-Lit Footlocker Face Indicia,” which is incorporated herein by reference for all purposes.

### BACKGROUND

### 1. Field of the Invention

The present invention generally relates to the field of face indicia for lockers. More particularly, the present invention generally relates to edge-lit locker doors and panels having illuminated indicia formed within one or more substrate panels.

### 2. Description of Related Art

Lockers and similar storage enclosures are widely used for storing athletic equipment, school supplies, tools, firearms, ammunition, and other personal or commercial items. Such lockers commonly include multiple access doors or panels that may be visually identified by numbers, names, logos, instructions, or other indicia. In certain applications, including educational, athletic, industrial, and commercial environments, it is desirable for such indicia to be visible in low-light conditions or to provide an enhanced visual appearance. As a result, various illuminated signs and display panels have been developed for use on doors, cabinets, and other surfaces, typically employing transparent or translucent glass or plastic panels in combination with one or more light sources positioned behind the panel.

Conventional illuminated panels often rely on rear-mounted or indirect light sources that illuminate indicia from behind the panel. In an attempt to distribute light across the visible surface, some panels incorporate grid-like etching, dot patterns, or similar light-scattering features. However, such approaches frequently result in non-uniform illumination, including visibly intensified regions along etched lines or at pattern intersections, rather than a smooth or selectively controlled light distribution. Additionally, many known illuminated panels are relatively complex, costly to manufacture, or poorly suited for integration into locker doors and similar enclosures. As a result, lockers that incorporate face-lit or illuminated panels often fail to achieve low-cost, uniform, or aesthetically controlled illumination, and in many cases rely on indirect lighting arrangements that do not provide a true self-illuminated or face-illuminated effect. Accordingly, there remains a need in the art for improved illuminated panels for lockers and similar enclosures that address these and other shortcomings.

Accordingly, there exists a long felt but yet unmet need in the art for edge-lit locker doors and panels having illuminated indicia formed therein.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIGS. 1 through 4 are elevation views of lockers incorporating the illuminated indicia panel according to the present application;

FIG. 5A is an enlarged, exploded view of a substrate panel and a border light strip according to the present application;

FIG. 5B is side view of a substrate panel from FIG. 5A according to the present application;

FIG. 6A is an enlarged, exploded view of a substrate panel and a border light strip according to the present application;

FIG. 6B is side view of a substrate panel from FIG. 5A according to the present application;

FIG. 7 is an enlarged, exploded view of a substrate panel with edge lighting according to the present application;

FIG. 8 is an enlarged, exploded view of a substrate panel with back lighting according to the present application;

FIGS. 9 through 12 are enlarged, exploded views, of front surfaces of treated illuminated panels with texture and/or etch patterns according to the present application;

FIGS. 13A through 13C are enlarged, exploded views of texture and/or etch patterns for indicia;

FIG. 14 is a method of forming an illuminated panel according to the present application;

FIG. 15A is an enlarged exploded view of a layered insert assembly including a base panel, interface panel, and acrylic insert according to the present application;

FIG. 15B is a top-down view of an insert flange according to the present application;

FIG. 16A is a top-down assembled view of the layered insert assembly including the insert flange of FIG. 15B according to the present application;

FIG. 16B is a perspective view of an illuminated insert according to the present application;

FIG. 17A is an enlarged view of the layered insert assembly of FIG. 16A coupled with the illuminated insert of FIG. 16B according to the present application;

FIG. 17B is a frontal perspective view of an exemplary embodiment of a self-lit locker according to the present application; and

FIG. 18 is an alternative method of forming an illuminated panel according to the present application.

While the assembly of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the self-lit footlocker with face indicia are provided below. It will of course be appreciated that in the development of any actual embodiment, numerous implementation-specific decisions will be made to achieve the developer’s specific goals, such as compliance with assembly-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

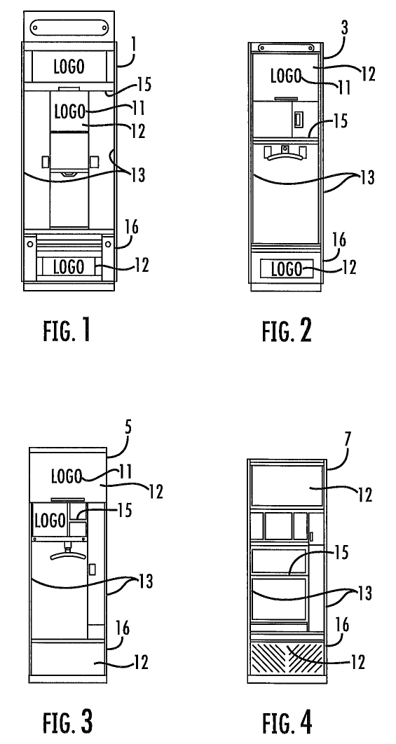

Referring now to FIGS. 1 through 4 in the drawings, four configurations of lockers 1, 3, 5, 7, each having one or more illuminated indicia 11 incorporated within one or more panels 12 according to the present application are illustrated. As can be seen, each locker 1, 3, 5, 7 comprises a pair of upstanding sidewalls 13 that generally define the extent of the locker. Each locker may be installed adjacent to another, similar or identical locker, with its rear against a wall, and its front facing the interior of the locker room.

Between the sidewalls 13 of each locker 1, 3, 5, 7, a plurality of compartments 15 are defined by shelves or other horizontally extending surfaces or platforms. The plurality of compartments includes a foot compartment 16. The foot compartment 16 is at the foot-level, or is intended to house foot gear, such as cleats, boots, ice skates, and similar foot gear. Multiple additional sidewalls may be placed between the “main” or exterior sidewalls 13 to define compartments along with horizontal shelves and the like. As used herein, “sidewall” or “sidewalls” may refer to either “main” sidewalls 13 or other sidewalls arranged between the “main” sidewalls. Each compartment 15 may be sized and otherwise configured for storage of clothing, sporting equipment, ammunition, hunting equipment, construction equipment, police and military equipment, or other items, and may include one or more doors, which may be lockable.

Each of the lockers 1, 3, 5, 7 also incorporates one or more panels 12 with illuminated indicia 11 (by illuminating a panel 12) according to an embodiment of the present application. In each example, an illuminated panel 12 is connected to a power source 14 and takes the form of a door giving access to a compartment behind the door, but the illuminated panel 12 may be merely structural or cosmetic and have no other function. The indicia 11 may take the form of graphic art (the paw print and wildcat profile of FIGS. 1 and 2), lettering or logos comprised of stylized lettering (the UK of FIG. 3), or printed artwork on a single, monolithic illuminated panel 12 as in the case of FIG. 4 (artwork is omitted for clarity).

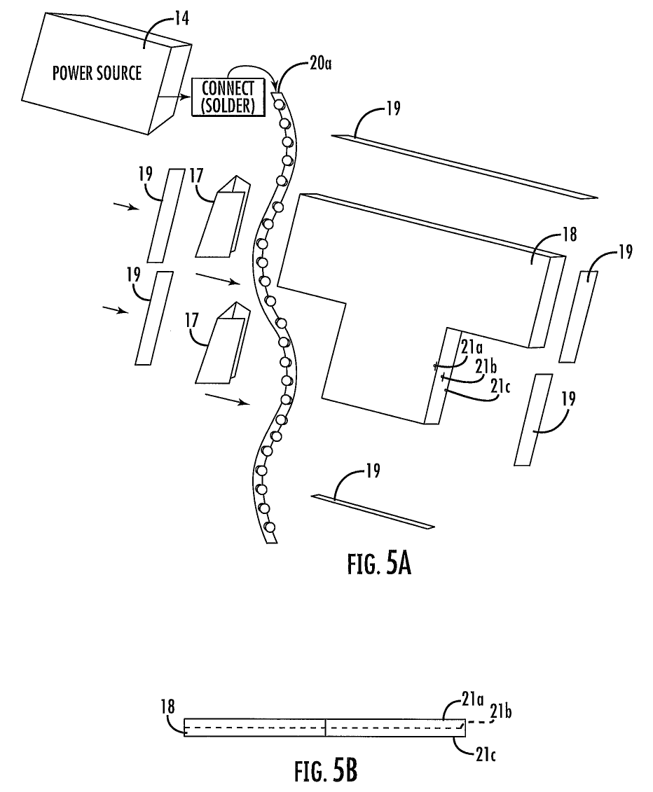

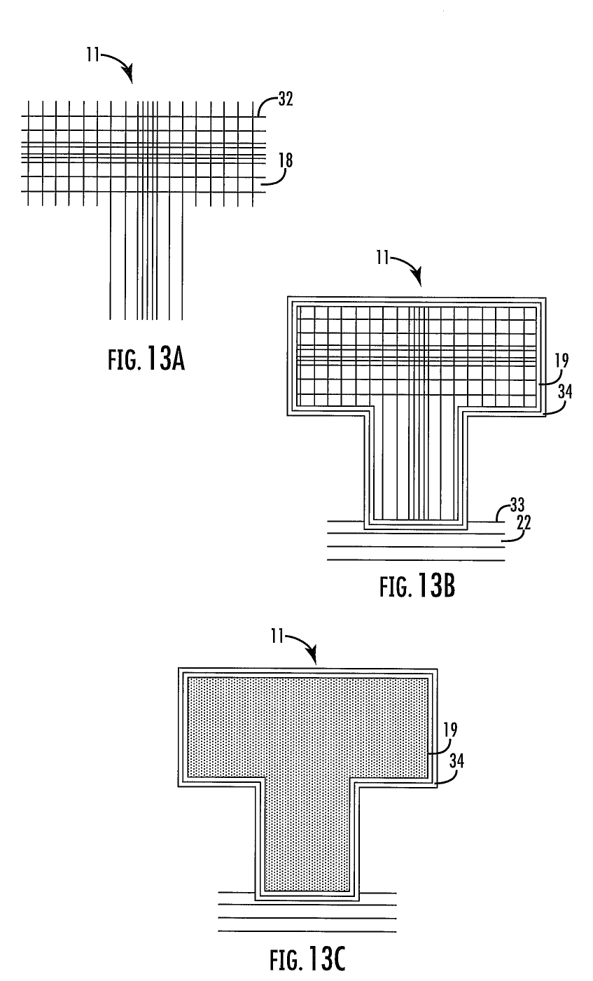

Referring now also to FIG. 5A, indicia 11 is combined with an edge light 20, such as flexible strip light 20a, and attachment means 17, such as an edge clamp, as illustrated. The combination of a light source, the attachment means, and a power source creates an illuminated panel 12. The length of strip light 20a varies depending on the dimensions of the indicia substrate panel 18. The attachment means 17 includes adhesives, fasteners, edge clamps, or combinations thereof. In a preferred embodiment, strip light 20a is placed around the outer edge of indicia substrate panel 18 and attached with the edge clamp. The indicia substrate panel 18 is a layer of clear, transparent, or translucent material and is shaped into a specified indicia, such as the letter “T”. The translucent material includes, but is not limited to, glass, plastic, quartz, and acrylic materials. In a preferred embodiment, the indicia substrate panel 18 is made of an acrylic material, such as Plexiglas, Lucite, Acrylite, and Perspex. The indicia substrate panel 18 may also include texturing, patterning, or another colored substrate layer incorporated on top or underneath the panel (see FIGS. 13A through 13C below).

In a preferred embodiment, a metal border or frame 19 is positioned around the indicia substrate panel 18 and the attached strip light 20a. It is noted that although steel perimeter 19 is depicted as multiple, discrete framing pieces, the steel perimeter 19 can also be a continuous metal sheet or strip surrounding the indicia substrate panel 18 and the attached strip light 20a. Further, although the term “steel perimeter” is used, other materials, such as aluminum, plastic, fiber glass, and similar low-cost, light-weight opaque materials may be used. In at least one embodiment, the steel perimeter 19 separates the light from the illuminated indicia panel from a second, surrounding illuminated panel.

The edge light 20 is comprised of multiple, discrete lights, such as incandescent, fluorescent, or light-emitting diode (LED) lights, but preferably includes LED lights. In another embodiment, edge light 20 includes a continuous strip of light, or at least one single or unibody edge lighting element, such as an LED strip light.

Edge light 20 includes a light source and its appropriate wiring for electric power. Edge light 20 may be coupled (e.g., as with soldering) either to a power source 14 contained elsewhere in or external to the locker or within the enclosure formed by the main sidewalls 13. The power source 14 may include dimmers, timers, switches and the like to turn off, dim, blink or otherwise manipulate the lighting emitting from edge light 20. The power source 14 may be a battery, a generator, or a direct AC/DC power source. Preferably, the lighting element is a strip or edge array of a plurality of white or colorless LEDs molded or otherwise formed into an exterior, interior, or posterior border, as illustrated. Discrete LEDs, LED tubes, continuous LED strips, incandescent, fluorescent, or other lighting elements may be appropriate. Colors other than white may be utilized, including combinations of colors. In a preferred embodiment, the LEDs or other lighting elements provides illumination for “edge lighting” or transmitting and distributing light along the edges of translucent or transparent portions, sheets, layers, or panels secured to a door of a compartment 15 and/or 16. In another embodiment, the LEDs or other lighting elements provides illumination for “back lighting”, such as an LED panel positioned behind an acrylic sheet.

In at least one embodiment, the light source is activated by a motion sensor. For example, active radio or microwave sensors, passive infrared sensors, or a combined hybrid motion sensor is used to activate edge light 20.

In at least one embodiment, the indicia 11 includes a texture or a pattern. The texture or pattern is formed by engraving, etching, laser engraving, or a combination thereof to correspond to the outline, lettering, or the graphic matter to be illuminated. In a preferred embodiment, the indicia may be a combination of graphic art, lettering, stylized lettering, or the like by cutting layers of glass or other substrates to correspond to the desired lettering, graphic art, or stylized lettering. In other embodiments, the substrate layers forming indicia may be chemically, mechanically, or magnetically adhered to an illuminated panel 12.

Referring now also to FIG. 5B, in a preferred embodiment, indicia substrate panel 18 incorporates the texture or pattern at a predetermined location relative to a surface of the panel. For example, texture or pattern is formed on an exterior plane 21a, or top surface of the panel 18. Preferably the exterior plane 21a is parallel with the top or front surface of the indicia substrate panel 18.

In another embodiment, the texture or pattern is formed on an interior, or inside, plane 21b of the panel 18. A laser etching process, discussed below, enables locating and forming the texture or pattern at or on plane 21b. In another embodiment, indicia 11 is formed on a posterior, bottom, or back plane 21c of the panel 18.

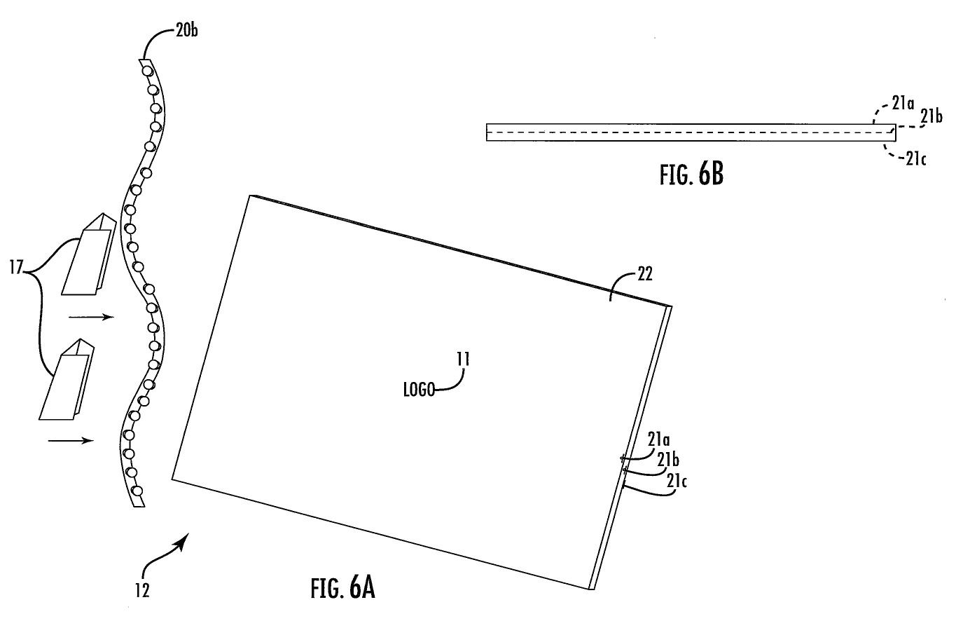

Referring now also to FIGS. 6A and 6B, in at least one embodiment, the indicia 11 is formed on a substrate panel by engraving, etching, laser engraving, or a combination thereof to correspond to the outline, lettering, or the graphic matter to be illuminated. The indicia 11 is formed on or in the surrounding substrate panel 22, such as on a surface corresponding to plane 21a. Strip light 20b is attached to the perimeter of the panel to form an illuminated panel 12. A steel perimeter 19 (see FIG. 5A) may also be positioned around all or a portion of the illuminated panel 12.

In other embodiments, the substrate layers forming indicia may be chemically, mechanically, or magnetically adhered to an illuminated panel 12. It is further noted that although substrate panel 22 is depicted as having only straight edges, in at least one embodiment, substrate panel 22 includes one or more curved edges.

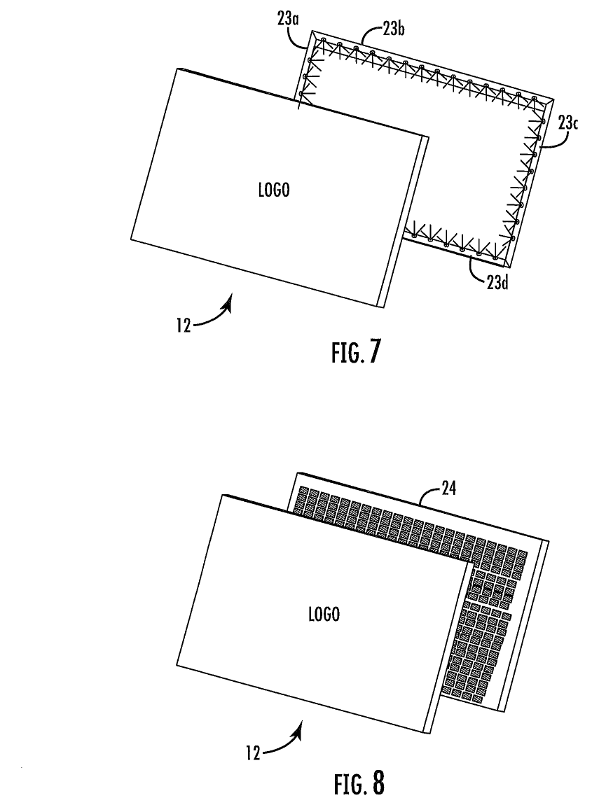

Referring now also to FIG. 7, a rigid edge light 23 is positioned relative to an edge of the panel 22, in lieu of strip light 20b, to direct light towards and illuminate the indicia. In a preferred embodiment, the rigid edge light 23 is positioned behind an edge of the panel 22; however, at least one embodiment includes positioning the rigid edge light 23 in front of a panel 22. In a preferred embodiment, an illuminated panel 12 incorporates multiple rigid edge lights connected together around a perimeter of panel 22, such as edge lights 23a, 23b, 23c, and 23d.

In embodiments using layered sheets of glass to form indicia 11 a single-color embodiment (as in the case of the paw of FIG. 1), only a single sheet of appropriately colored acrylic may be required and is dimensioned slightly larger than an aperture or outline to permit it to be secured to the reverse side of a door of a compartment by adhesives or fasteners. In multi-colored embodiments, two or more sheets of differently colored acrylic adhered together may be necessary. For example, in the UK embodiment of FIG. 3, a sheet of white acrylic is cut coextensive with and in the same outline as the aperture, but 0.25 inch smaller. The white sheet then is adhered to a blue sheet dimensioned to be secured to the reverse of the door. This produces an illuminated UK logo of white-outlined blue letters.

Referring now also to FIG. 8, in embodiments using the single-layer monolithic panel (FIG. 4), a single sheet of acrylic, preferably translucent or light-transmitting white, may be mounted within a steel perimeter frame by adhesives or fasteners. This combination then forms the door or panel. The panel 22 and a back light LED panel 24 are secured to a frame behind an acrylic sheet to form an illuminated panel 12. A removable graphics sheet, with printed or otherwise-applied graphics thereon, may be secured to the front of the acrylic sheet. The acrylic sheet is a translucent or transparent sheet (or may be opaque and contain graphic cut-outs or outlines). In at least one embodiment, the acrylic sheet is magnetically secured to a steel frame of a compartment door. This embodiment permits the graphics to be changed simply by removing and replacing the graphics sheet.

Graphics may also be implemented by combinations of the embodiments illustrated above, e.g. a translucent panel (FIG. 4) may be combined with a multi-layer graphic (FIGS. 2 and 3). The graphics may include an LED panel that is capable of displaying rudimentary or even full-motion or television-quality graphics. Such a panel may include the ability to display text banners and the like that are changeable via a programming module.

In a preferred embodiment, the illuminated panel 12 is incorporated in a door or a drawer of a foot compartment 16 of a locker. In other embodiments, the illuminated panel is incorporated in, or as, a door to any compartment of a locker. The illuminated panel 12 of the foot compartment 16 may include positive or negative lighting. For example, with negative lighting, the entire surface of the panel 12 is textured except for the letters or indicia 11, which clearly transmits light as through a glass or acrylic substrate. By way of another example, the indicia 11 may be textured using a first texture pattern that creates a more uniform distribution of light, while the remainder of the panel may be textured using a second texture pattern that is less uniform. For instance, the “TIGERS” indicia from locker 1 of FIG. 1 may be formed using a dot pattern, whereas the dark portions of panel 12 may be formed using a grid-like line pattern. By way of another example, the darkened portions of panel 12 in FIG. 1 may receive an acrylic paint, or another opaque texture that restricts the transmission of light, whereas the indicia 11 forming the word “TIGERS” may comprise a dot texture, a grid pattern, or no texture/pattern at all. With positive lighting, the darkened portions of panel 12 in FIG. 1 may receive the dot texture or no texture at all, while the indicia 11 forming the word “TIGERS” is darkened with paint or receives a non-uniform light distribution pattern.

Generally, with negative lighting the indicia on the panel transmits more light, or at least transmits a more uniform distribution of light, than the portions of the substrate panel surrounding it. With positive lighting, the portions of the substrate panel that surround the indicia transmit more light, or the more uniform distribution of light, than the indicia. In a preferred embodiment, the illuminated panel 12 incorporates negative lighting.

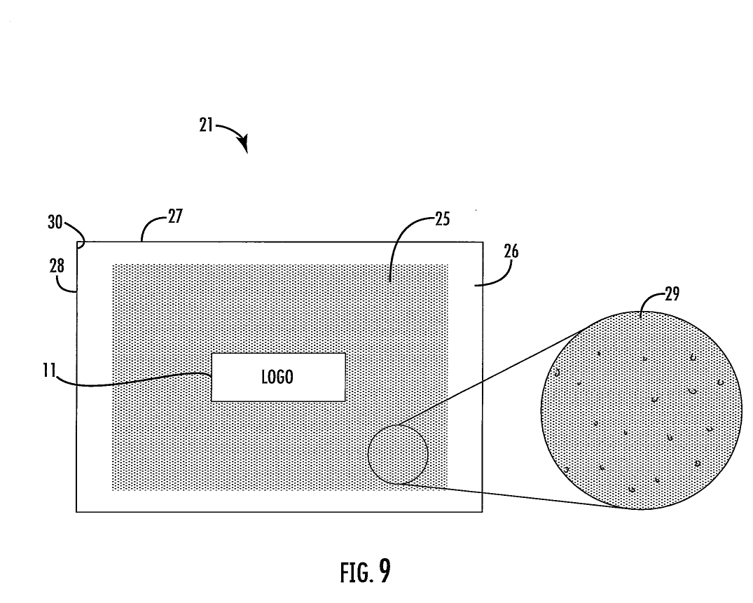

Referring now also to FIG. 9, a plane 21 parallel with a front surface of a substrate panel 22 is treated or texturized according to the present application. Treated substrate panel 22 comprises a texturized portion 25 and an untreated portion 26. Treated substrate panel 22 comprises a top edge 27, a side edge 28, and a texture 29 applied to, formed in, or formed on the texturized portion 25. The texturized portion 25 is formed in/on the substrate panel 22 relative to the top edge 27 and the side edge 28. For example, the texturized portion 25 may be centered relative edges of the panel, such as the top edge 27 and the side edge 28. The texturized portion 25 may also be left-aligned, right-aligned, off-centered, or a combination of alignments relative to either the top edge 27, the side edge 28, or the corner 30.

In other embodiments, the plane 21 may be at interior or exterior locations of the substrate panel 22. For example, the texture 29 may be formed on the interior plane 21b or the exterior plane 21c of panel 22. The interior plane 21b is a plane that is located at and runs laterally along a center axis of the substrate panel 22. It is noted that the centered location is not limiting, but it ensures maximum integrity of the substrate panel despite laser etching occurring at the interior of the panel. The exterior plane 21c is parallel with a back surface of the substrate panel and is generally located relative to the back surface.

As shown in FIG. 9, top edge 27 and side edge 28 are generally straight. Top edge 27 and side edge 28 are connected by a straight corner 30. In a preferred embodiment, straight corner 30 is replaced, or rounded, to form a beveled or curved corner.

Often substrate panels used in face-lit lockers are etched with a series of longitudinal lines and a series of lateral lines, creating a grid-like pattern in the panel. Since the grid-like pattern includes lines having a discrete and continuous depth, a light-channeling effect can occur. The light-channeling effect can cause light distortions at line intersections, resulting patchiness in panel presentation, dark spots, and other undesirable effects. Thus, although the grid-like pattern is symmetrically, uniformly, or non-randomly distributed in a substrate panel, it creates an undesirable non-uniform distribution of light.

In a preferred embodiment, texture 29 is formed from a randomized distribution of dots and/or micropores including circular, oblong, semi-spherical, or a combination of shapes sprayed, etched, spread, ground (as with diamond grinding), or otherwise distributed over, under, or through texturized portion 25. The dimensions of the dots forming the texture are small enough (e.g., one to 5,000 micrometers in diameter) along any axis such that light-channeling is minimalized, yet distributed over a sufficient surface area such that uniform light distribution throughout the texturized portion is substantially obtained. The dots can include indentations, such as with etching, or raised textures formed as with acrylic resins and/or cements placed on top of the substrate panel and allowed to cure.

Referring now also to FIGS. 10 through 12, in another embodiment, texture 29 includes a first pattern and a second pattern. For example, texture 29 includes dots formed on or in the same plane as longitudinal and/or lateral etching, thereby creating different areas of light emphasis. For instance, a first area of light emphasis 31a is formed using a dot pattern engraving and a second area of light emphasis 31b is formed using both lateral and longitudinal line etching/engraving. Preferably, the first area of light emphasis 31a differs from the second area of light emphasis 31b at least in that the first area of light emphasis 31a creates a more uniform light distribution than the second area of light emphasis 31b. The distribution or uniformity of the light may be measured by a photometer.

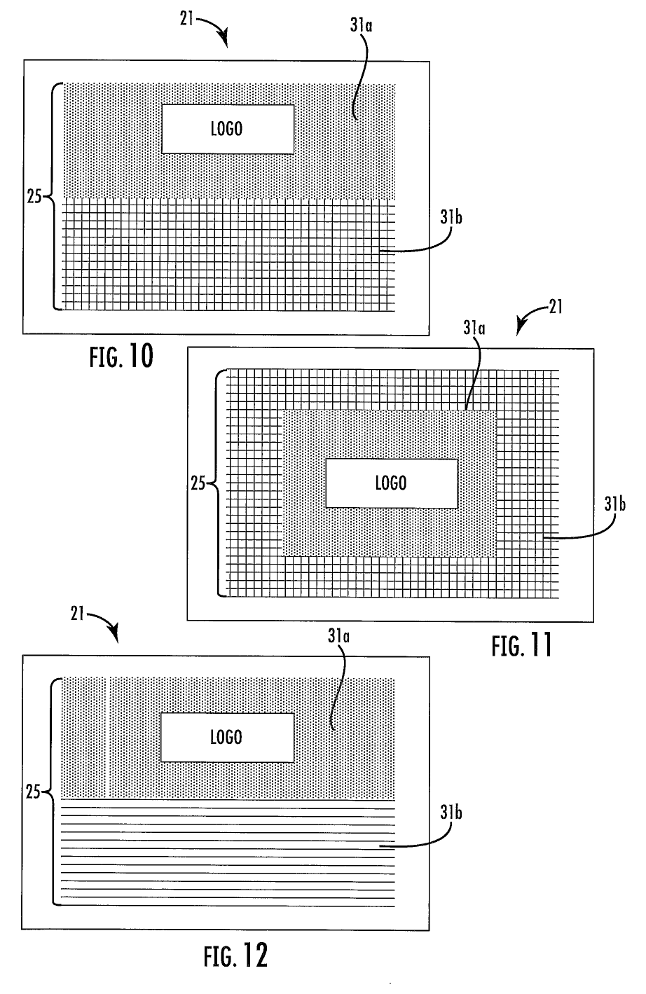

Referring to FIGS. 11 and 12, the different areas of emphasis may vary in location and in etching and/or engraving pattern. For example, the indicia 11 is the desired focal point of panel 12, and therefore may be directly surrounded by texture 29, and then surrounded indirectly by the longitudinal and lateral etching, as depicted in FIG. 11. The longitudinal and lateral etched portion may include only a single directional type of etching/engraving, such as the lateral etching depicted in FIG. 12. Different patterns and arrangements of etching, including etching or engraving of indicia 11, will be recognized by those of skill in the art, and are encompassed by the features of the present application.

In a preferred embodiment, texturized portion 25 is preferably formed using an etching process. For example, an acid, such as hydrofluoric acid, hexaflurosilicic acid (H₂SiF₆), acidulated phosphate fluoride (APF), and ammonium hydrogen difluoride, is distributed over a substrate panel to wet etch the panel and create the texturized portion. Other materials, such as creams, caustics, abrasives, and combinations thereof, may be used in the wet etching processes disclosed herein. By way of another example, plasma etching and/or abrasives are used to dry etch the substrate panel and form the texture of randomized dots.

In another embodiment, an interior or sub-surface portion of the substrate panel is engraved using a laser process and system. For example, the system includes a laser diode, and the process includes importing a mesh file or a JPEG file that has been 3-D formatted as a matrix of dots to be etched within an interior of the glass. The process further includes establishing a focal point for the laser diode at a point that falls within the interior of the glass. In this embodiment, the quality of the glass used increases at least with respect to optical clarity. For example, an optical crystal from 0.5 inches to 3 inches in thickness may be used in this embodiment. A size of the dots formed using sub-surface laser engraving is approximately 3,700 to 4,700 micrometers in diameter.

It is noted that although randomized distributions of dots are discussed as forming the texturized portion 25 of a substrate panel, other dot distributions are encompassed herein. For example, plasma etching may result in a non-random pattern of dots formed in glass, creating a sort of dot matrix.

Referring now also to FIGS. 13A through 13C in the drawings, the logo or indicia 11 is illustrated as a letter “T”, formed using a texturized or etched pattern 32 on a substrate panel 18 that is also in the shape of the letter “T”. The texturing or patterning 32 is performed relative to one or more edges of the substrate panel 18, and may be centered, left-offset, right-offset, left-aligned, right-aligned, or combinations thereof. It is noted that although the substrate indicia panel 18 is depicted having straight lines forming a “T”, other indicia including letters with curved lines, such as the letter “D”, may also be formed.

In a preferred embodiment, the texturing or patterning 32 of the indicia 11 may occur, as in FIG. 13A, prior to the texturing or patterning 33 of a surrounding substrate panel 22, as in FIG. 13B. The surrounding substrate panel 22 includes a cut-out portion 34 in the shape of the letter “T” slightly larger in dimension than the T-shaped indicia substrate panel 18. The T-shaped panel 18, including the attached light strip, is inserted into the cut-out portion of panel 22. In at least one embodiment, the surrounding substrate panel 22 is incorporated with a back lighting LED panel 24 that is in the associated compartment or another portion of the locker. In a preferred embodiment, the illuminated T-shaped panel is framed by steel perimeter 19.

In at least one embodiment, the pattern on indicia 11 may be a non-uniform distribution of gridlines, as in FIGS. 13A and 13B. In a preferred embodiment, the indicia 11 is texturized with a dot pattern, as in FIG. 13C. The dot pattern may be uniformly distributed dots or non-uniformly distributed dots, and positioned on the interior, exterior, or posterior of the substrate panel depending on the desired distribution of illumination.

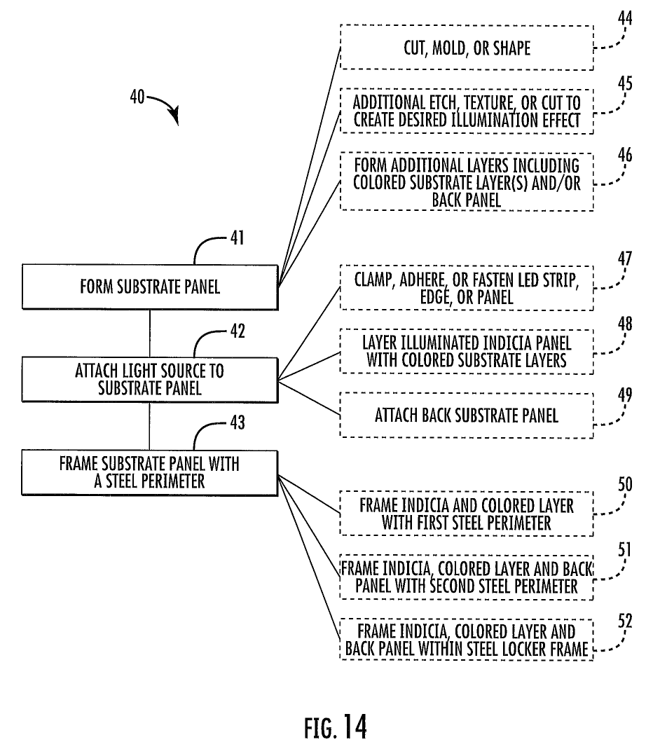

Referring now also to FIG. 14, a method 40 of forming an illuminated panel for a face-lit foot locker that is self-lighting is illustrated. Step 41 includes forming a substrate panel. For example, a clear (non-colored), transparent, or translucent substrate panel 18 may be etched or engraved to place the desired pattern or texture thereon/therein.

Step 42 includes attaching a light source to the substrate panel. For example, a flexible strip light 20 may be clamped around an edge of the acrylic sheet formed in Step 41. Step 42 includes attaching a power source to the light source, or at least attaching a connector that interfaces with the power source, such as wiring, to the light source. The attachment is preferably by soldering, but includes other electrical attachment means, such as conductive adhesives, solderless headers, clip wires, splicing leads, and combinations thereof.

Step 43 includes framing the substrate panel with a steel perimeter. For example, the substrate panel 18 may be framed in a steel border/frame.

In a preferred embodiment, the method 40 includes additional steps or sub-steps. For example, step 41 includes steps 44, 45, and 46; step 42 includes steps 47, 48, and 49; and step 43 includes steps 50, 51, and 52.

Step 44 includes cutting a T-shape from an acrylic sheet. By way of another example, step 44 includes molding or shaping the T-shaped indicia from an acrylic resin.

Step 45 includes additional texturing, patterning, or cutting to create the desired illumination effect. For example, the surrounding panel 22 may be patterned or etched.

Step 46 includes forming additional substrate layers. For example, a colored T-shaped substrate indicia panel 18 may be formed and/or etched. By way of another example, a graphics sheet or a back LED panel may be formed and/or assembled.

Step 47 includes attaching additional light sources to one or more substrate panels. For example, light strip 20b may be attached around the surrounding panel 22. In at least one embodiment, Step 47 is optional, and includes attaching the back LED panel to the illuminated panel 12 formed from a single-layer substrate indicia panel 18. Step 47 is optional because not all embodiments disclosed herein use the LED back lighting panel 24. Step 47 may also be performed in a different order if a multi-layer substrate panel 18 (e.g., clear and colored layers) is used to form an illuminated panel.

Step 48 includes layering one or more substrate panels or layers with at least one additional substrate panel or layer. For example, a colored T-shaped substrate indicia panel 18 may be layered on top of the clear substrate panel formed in Step 41. By way of another example, a graphics sheet or a back LED panel may be layered with an illuminated panel 12.

Step 49 includes clamping the back-most substrate panel/layer together with the first substrate panel. For example, a colored substrate indicia panel 18 may be the rearmost substrate panel and is clamped to the clear substrate indicia panel 18.

Step 50 includes framing the indicia with a first steel perimeter. For example, the clear T-shaped substrate panel 18 layered with the colored T-shaped substrate panel 18 is framed with the first steel perimeter. The first steel perimeter seals the light from the indicia substrate panel(s), containing it to those substrate panels and preventing further transmission of light to surrounding substrate panels.

Step 51 includes framing the illuminated panel with a second steel perimeter. For example, the framed clear and colored substrate panels 18 are inserted into a cut-out of the surrounding substrate panel 22. The surrounding substrate panel is then framed with a second steel perimeter 19 that encompasses the attached strip light 20b and the perimeter of the surrounding substrate panel 22. Step 51 includes attaching a cover plate over the indicia substrate panels and the surrounding substrate panel.

Step 52 includes framing the illuminated panel within the steel perimeter of the locker. For example, after the surrounding substrate panel is framed, the multiple substrate layers and cover plate are sealed by fastening the illuminated panel to foot compartment 16 within the main sidewalls 13. In a preferred embodiment, at least steps 44-46 of method 40 are repeated to form other letters (“I”, “G”, “E”, “R”, and “S”) of the Clemson Tigers indicia of locker 1. In another embodiment, the colored substrate indicia panel 18 is orange and the steps form a single letter “T”, such as in the logo for the Tennessee Volunteers. Step 52 also includes activating the power source such that the indicia is illuminated or the timers, dimmers, and motion sensors are activated.

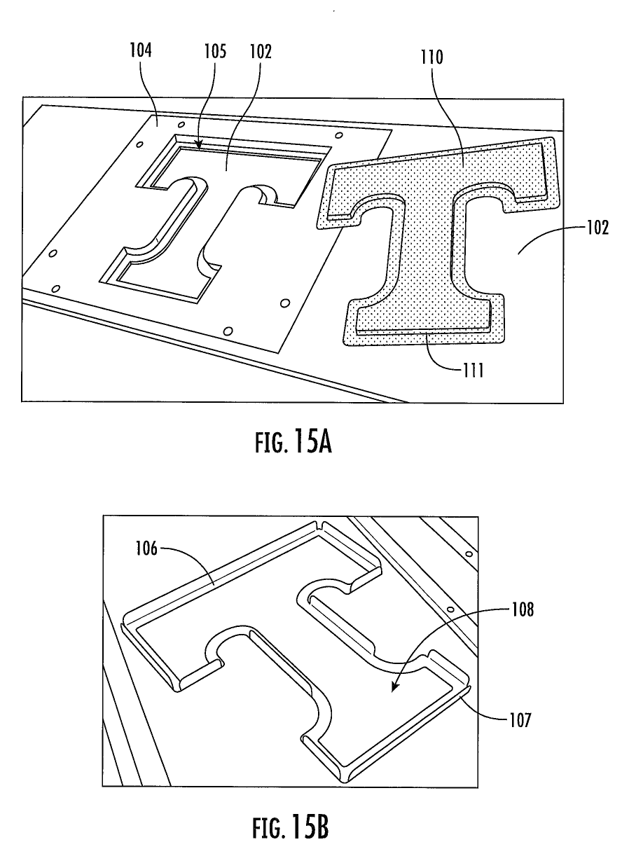

Referring now also to FIG. 15A, FIG. 15A illustrates an exploded perspective view of a layered insert assembly configured for use in an illuminated locker door or similar structure. The assembly includes a base panel 102, an interface panel 104 positioned relative to the base panel 102, and a light-transmissive acrylic insert 110 configured to be received within an opening defined by the interface panel 104. Interface panel 104 defines an interface cavity 105 corresponding in shape to the acrylic insert 110. Acrylic insert 110 includes a perimeter insert lip 111 configured to engage a retention structure associated with the interface cavity 105. In the configuration shown, interface panel 104 is positioned over base panel 102 and defines a shaped opening corresponding to indicia to be illuminated. Acrylic insert 110 is dimensioned to be received within interface cavity 105 such that acrylic insert 110 occupies the opening defined by interface panel 104 while cooperating with surrounding structural components to form an illuminated insert region within the door assembly.

Base panel 102 comprises a structural substrate configured to support the layered insert assembly. Base panel 102 may form part of a locker door or other enclosure structure and provides a rigid backing surface for components of the illuminated insert assembly. Base panel 102 may be formed from materials including metal, polymeric materials, composite materials, or combinations thereof, and base panel 102 may define mounting apertures, fastener openings, or structural features used to secure the layered insert assembly within the door structure. In certain embodiments, base panel 102 provides a mounting plane against which interface panel 104 and other components of the insert assembly are positioned during assembly.

Interface panel 104 comprises a carrier panel positioned relative to base panel 102 and defining the interface cavity 105 through which the illuminated indicia is visible. Interface panel 104 may be formed from opaque or non-light-transmissive materials configured to mask regions surrounding the illuminated insert. Interface cavity 105 may be formed by routing, cutting, molding, laser cutting, or other material removal processes to produce a shaped opening corresponding to a logo, symbol, text element, or other indicia. Interface panel 104 may further define a recessed seat or mounting region surrounding interface cavity 105 configured to receive retention components associated with acrylic insert 110. When assembled, interface panel 104 cooperates with base panel 102 to establish a structural boundary surrounding the illuminated insert region.

Acrylic insert 110 comprises a light-transmissive panel configured to receive illumination from a lighting assembly and emit visible light through the shaped opening defined by interface cavity 105. Acrylic insert 110 may be formed from acrylic, polycarbonate, glass, or other transparent or translucent materials capable of transmitting light. More generally, it should be understood that acrylic insert 110 can be formed from any polymeric material and is not limited to certain polymers. Acrylic insert 110 includes insert lip 111, which extends along at least a portion of the perimeter of acrylic insert 110 and is configured to cooperate with a retention structure positioned along the perimeter of interface cavity 105. Insert lip 111 may define a stepped, flanged, or otherwise shaped edge that permits acrylic insert 110 to be captured or retained by surrounding structural elements during assembly. In certain embodiments, acrylic insert 110 may be clear, tinted, colored, or otherwise include pigments, dyes, coatings, or embedded materials configured to impart a selected color or visual effect to emitted light. More generally, it should be understood that acrylic insert 110 may be formed from any suitable light-transmissive material and is not limited to the exemplary materials expressly disclosed herein. Acrylic insert 110 includes insert lip 111, which extends along at least a portion of the perimeter of acrylic insert 110 and is configured to cooperate with a retention structure positioned along the perimeter of interface cavity 105. Insert lip 111 may define a stepped, flanged, or otherwise shaped edge that permits acrylic insert 110 to be captured or retained by surrounding structural elements during assembly.

Referring now also to FIG. 15B, a retention structure configured to receive acrylic insert 110 is shown. The retention structure may include an insert flange 106 configured to engage the perimeter of interface cavity 105. Insert flange 106 may define a surrounding frame member that engages or captures insert lip 111 of acrylic insert 110. Insert flange 106 further includes a flange lip 107 that extends inwardly relative to the flange body and defines an engagement surface configured to retain acrylic insert 110 within the assembly. In certain embodiments, insert flange 106 additionally defines a flange channel 108 configured to receive insert lip 111 of acrylic insert 110. Flange channel 108 may be configured as a recessed channel, groove, or pocket extending along at least a portion of the perimeter of insert flange 106. The flange channel 108 and flange lip 107 cooperate to mechanically capture acrylic insert 110 within the retention structure.

Insert flange 106 may be formed from metal, aluminum, steel, polymeric materials, or composite materials and may be manufactured using extrusion, machining, casting, or stamping processes. In some implementations, insert flange 106 defines a continuous perimeter frame configured to surround acrylic insert 110, while in other implementations insert flange 106 may comprise multiple frame segments positioned around portions of the perimeter of acrylic insert 110. Insert flange 106 provides mechanical retention of acrylic insert 110 and maintains positional alignment between acrylic insert 110 and interface panel 104 during operation of the door assembly.

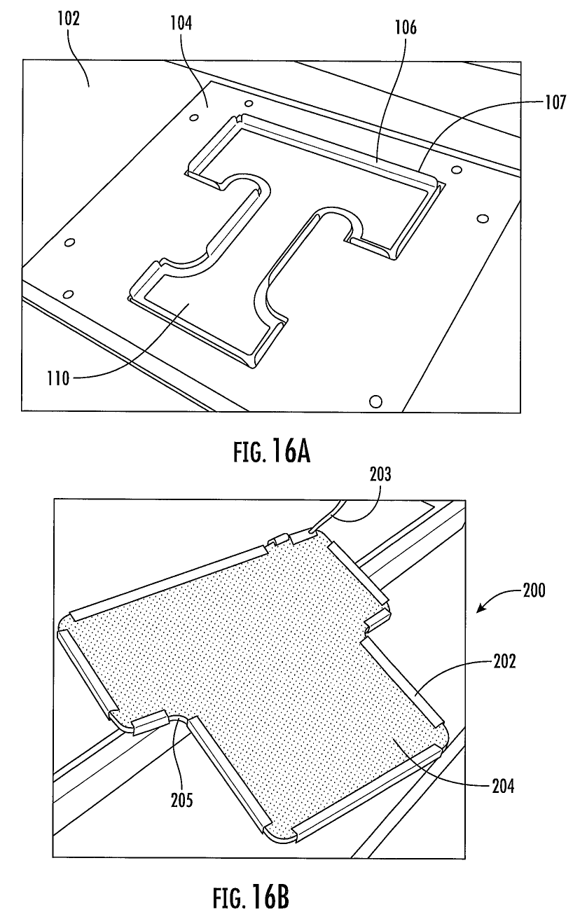

Referring now also to FIG. 16A, acrylic insert 110 is shown positioned relative to interface panel 104 and base panel 102 during assembly. In the configuration illustrated, acrylic insert 110 is positioned within interface cavity 105 such that insert lip 111 engages flange channel 108 of insert flange 106. Flange lip 107 cooperates with insert lip 111 to retain acrylic insert 110 in a fixed positional relationship relative to interface panel 104. Insert flange 106 may be secured relative to interface panel 104 and/or base panel 102 using fasteners, adhesives, mechanical clips, or other attachment mechanisms. The resulting arrangement positions acrylic insert 110 within the opening defined by interface cavity 105 while maintaining structural support for the insert assembly.

Referring now also to FIG. 16B, a lighting assembly 200 configured to illuminate acrylic insert 110 is shown. Lighting assembly 200 includes a light-emitting element in the form of an LED strip 205 positioned adjacent a perimeter edge of acrylic insert 110. LED strip 205 may comprise a flexible, continuous strip of light-emitting diodes configured to extend along one or more perimeter edges of acrylic insert 110 and to emit light toward an edge surface of acrylic insert 110. Lighting assembly 200 may further include a plurality of retention features 202 positioned at discrete locations along the perimeter edge of acrylic insert 110. Retention features 202 may be configured to secure LED strip 205 relative to acrylic insert 110 while permitting portions of LED strip 205 to extend between adjacent retention features. Lighting assembly 200 further includes a power lead 203 configured to supply electrical power to LED strip 205 from an external power source.

Lighting assembly 200 may additionally include a light diffusion layer 204 positioned relative to acrylic insert 110. Diffusion layer 204 may comprise a translucent sheet, optical diffuser panel, mesh diffuser, patterned film, or other light-distributing element configured to distribute light emitted by LED strip 205. Diffusion layer 204 may be positioned behind or adjacent acrylic insert 110 to promote uniform illumination across the visible surface of the insert. Diffusion layer 204 may also reduce visible hot spots or localized brightness variations resulting from localized emission along LED strip 205.

In operation, LED strip 205 emits light toward the perimeter edge of acrylic insert 110. The emitted light enters acrylic insert 110 and propagates within the body of the acrylic insert by internal reflection and scattering mechanisms. Light traveling within acrylic insert 110 is distributed across the shape of the insert and emerges through a front surface of acrylic insert 110 corresponding to the indicia defined by interface cavity 105. Retention features 202 maintain LED strip 205 in position relative to the perimeter edge of acrylic insert 110 during operation. Diffusion layer 204 cooperates with acrylic insert 110 to produce a visually uniform illuminated region corresponding to the shape of the insert.

Retention features 202 may comprise clips, brackets, channels, covers, or other mechanical securing elements configured to engage and retain LED strip 205 along the perimeter of acrylic insert 110. Retention features 202 may be formed from polymeric, metallic, or composite materials and may be coupled to adjacent structural components, including insert flange 106 or interface panel 104. In some embodiments, retention features 202 may partially enclose LED strip 205 to maintain alignment with the perimeter edge while permitting light emission toward acrylic insert 110. LED strip 205 may comprise a flexible printed circuit supporting a plurality of light-emitting diodes arranged along a continuous length, and may be configured to conform to linear segments and curved corner regions of the perimeter of acrylic insert 110. In operation, LED strip 205 provides a continuous light source extending along at least a portion of the perimeter, while retention features 202 maintain positional stability and routing of LED strip 205, thereby facilitating consistent optical coupling of emitted light into acrylic insert 110 along the perimeter thereof. Light emitted from LED strip 205 may pass through diffusion layer 204 prior to entering acrylic insert 110. Diffusion layer 204 may scatter and redistribute the emitted light to reduce localized intensity variations and promote more uniform optical coupling along the perimeter of acrylic insert 110. As a result, light entering acrylic insert 110 through diffusion layer 204 may exhibit a more consistent spatial distribution, thereby enhancing uniform illumination across the visible surface of the insert.

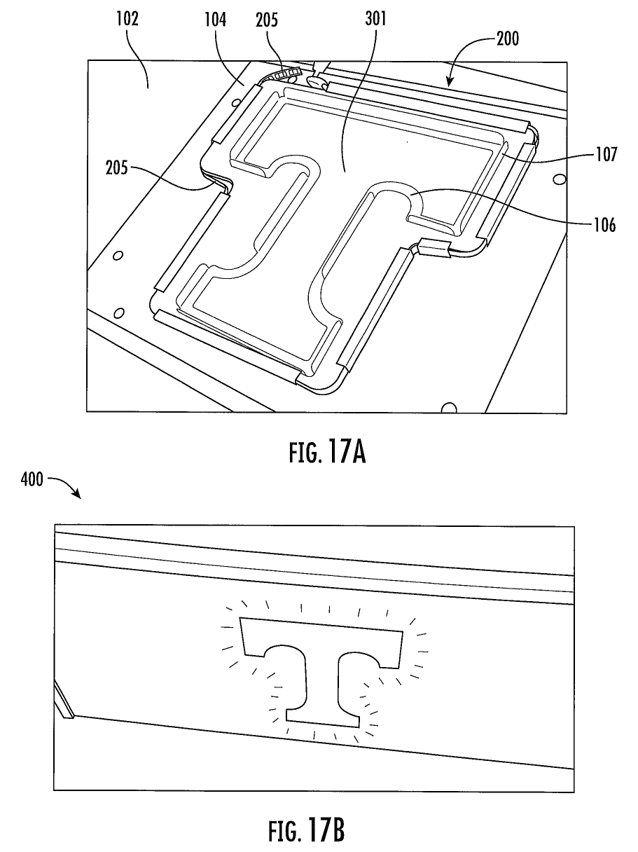

Referring now also to FIG. 17A, additional layers may be incorporated into the insert assembly to produce a desired visual appearance. In certain embodiments, a colored indicia layer 301 may be positioned relative to acrylic insert 110. Colored indicia layer 301 may comprise a printed film, colored sheet, adhesive-backed graphic element, or decorative layer configured to impart color or graphic detail to the illuminated indicia. Colored indicia layer 301 may include a pressure-sensitive adhesive and a removable protective liner that is removed during assembly to secure the layer in a desired position relative to acrylic insert 110. Colored indicia layer 301 may be positioned on a rear surface of acrylic insert 110, between acrylic insert 110 and diffusion layer 204, or in other locations within the layered assembly depending on the desired visual effect.

The layered components including acrylic insert 110, diffusion layer 204, and colored indicia layer 301 may be retained together by insert flange 106 and associated structural components to form a multi-layer insert stack. Insert flange 106 maintains alignment between the layered components while preventing displacement of the layers during handling or operation of the door assembly. In certain embodiments, adhesives, fasteners, clips, or pressure-fit engagement between insert lip 111 and flange channel 108 may be used to secure the layered stack within the assembly.

Referring now also to FIG. 17B, the assembled insert structure forms an illuminated insert assembly 400 configured to be installed within a locker door or similar panel structure. Illuminated insert assembly 400 may be positioned within an opening of a door panel such that the illuminated indicia is visible from an exterior surface of the door. Base panel 102 and interface panel 104 cooperate to support illuminated insert assembly 400 within the door structure while concealing structural components positioned behind the illuminated region.

When lighting assembly 200 is energized, LED strip 205 emit light that propagates through acrylic insert 110 and is distributed across the shape of the insert. Diffusion layer 204 promotes uniform light distribution across the illuminated region, while colored indicia layer 301 may impart a desired color or visual effect to the emitted light. The resulting configuration produces a visually distinct illuminated indicia corresponding to the shape defined by interface cavity 105.

During operation of the locker door, insert flange 106 and associated retention features maintain the layered insert assembly in a fixed positional relationship relative to interface panel 104 and base panel 102. Mechanical loads generated by door movement, vibration, or user interaction are resisted by insert flange 106 and flange lip 107, which retain acrylic insert 110 within flange channel 108. The described arrangement maintains alignment between acrylic insert 110 and the surrounding structural components while preserving consistent illumination during repeated operation cycles.

In certain embodiments, lighting assembly 200 may include multiple edge lighting elements positioned along different edges of acrylic insert 110 to increase illumination uniformity across the insert. LED strip 205 may be arranged along one or more sides of acrylic insert 110 depending on the desired light distribution and available installation space within the door assembly.

Although illustrated with specific structural components, the layered insert assembly described herein may be implemented using various materials, geometries, and attachment mechanisms. The interface cavity 105 may define shapes corresponding to logos, text, symbols, or other indicia, and the dimensions of acrylic insert 110 and associated layers may be adapted accordingly. The described arrangement provides a compact illuminated insert assembly that can be integrated within a door panel while providing durable mechanical retention and visually uniform illumination.

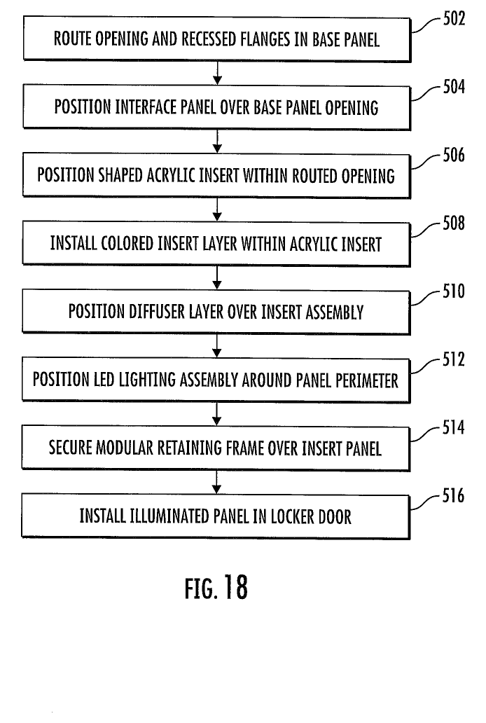

Referring now also to FIG. 18, a method 500 of forming an illuminated insert assembly for a self-lit locker door or similar enclosure is illustrated. Method 500 includes forming an opening within a base panel, positioning an interface panel relative to the base panel, positioning a shaped acrylic insert within the opening, assembling one or more illumination-related layers relative to the acrylic insert, securing the assembled layers with a retaining structure, and installing the illuminated insert assembly within a locker door or similar structure.

Step 502 includes routing an opening and recessed flanges in a base panel. For example, a base panel may be cut, machined, routed, molded, or otherwise formed to define an opening corresponding to a desired indicia shape, symbol, letter, logo, or pattern. In certain embodiments, the routed opening is configured to receive an insert assembly, and one or more recessed flange regions are formed relative to the opening to receive or accommodate a retention structure associated with the insert assembly. The base panel may comprise metal, polymeric materials, composite materials, wood-based materials, or combinations thereof.

Step 504 includes positioning an interface panel over the base panel opening. For example, an opaque or non-light-transmissive interface panel may be positioned relative to the base panel such that an interface cavity or shaped opening of the interface panel is aligned with the routed opening of the base panel. In certain embodiments, the interface panel is adhered, fastened, laminated, or otherwise secured to the base panel. The interface panel may be configured to define a visible boundary for an illuminated insert region and to mask surrounding non-illuminated portions of the door assembly.

Step 506 includes positioning a shaped acrylic insert within the routed opening. For example, a clear, transparent, or translucent acrylic insert may be cut, molded, machined, or shaped to correspond to the indicia shape defined by the opening in the interface panel and/or the base panel. In some embodiments, the acrylic insert includes an insert lip configured to engage a flange, channel, or other retention feature associated with the opening. Step 506 may include positioning the acrylic insert such that the acrylic insert is substantially flush with, recessed from, or proud of a surrounding surface of the interface panel, depending on the desired appearance of the illuminated insert assembly.

Step 508 includes installing a colored insert layer within the acrylic insert. For example, a colored indicia layer, printed film, decorative sheet, coated panel, or other colored layer may be positioned relative to the acrylic insert to impart a desired color or visual effect to the illuminated indicia. In certain embodiments, the colored insert layer is positioned behind the acrylic insert. In other embodiments, the colored insert layer is laminated to, adhered to, or otherwise secured relative to the acrylic insert. The colored insert layer may include a pressure-sensitive adhesive, a removable protective liner, or both, such that the liner is removed during assembly and the colored insert layer is then affixed in a desired position.

Step 510 includes positioning a diffuser layer over the insert assembly. For example, a diffuser sheet, mesh diffuser, optical diffuser panel, patterned film, translucent sheet, or other light diffusion layer may be positioned relative to the acrylic insert and/or colored insert layer. Step 510 may include positioning the diffuser layer so as to distribute light passing through the acrylic insert more uniformly across the indicia region. In certain embodiments, the diffuser layer is positioned adjacent a rear surface of the acrylic insert. In other embodiments, the diffuser layer is positioned behind the colored insert layer or otherwise within the layered insert stack.

Step 512 includes positioning an LED lighting assembly around the panel perimeter. For example, one or more edge lighting elements may be positioned adjacent one or more perimeter edges of the acrylic insert such that light emitted by the lighting elements is directed toward the acrylic insert. In some embodiments, the LED lighting assembly includes a flexible LED strip arranged along a portion or entirety of the perimeter of the acrylic insert. In certain embodiments, a power lead is electrically connected to the LED lighting assembly to provide power from an external power source. Step 512 may include selecting and positioning the LED lighting assembly such that light is injected into the acrylic insert from one or more perimeter locations.

Step 514 includes securing a modular retaining frame over the insert panel. For example, a retaining frame, flange, bezel, channel member, or perimeter retention structure may be positioned relative to the acrylic insert and surrounding layers to mechanically retain the insert assembly in a fixed positional relationship. In certain embodiments, the retaining frame captures an insert lip of the acrylic insert and cooperates with a flange channel to retain the acrylic insert. Step 514 may include securing the retaining frame to the base panel and/or the interface panel using fasteners, adhesives, mechanical clips, press-fit engagement, or combinations thereof. The retaining frame may maintain alignment between the acrylic insert, the colored insert layer, the diffuser layer, and the LED lighting assembly during handling and operation of the locker door.

Step 516 includes installing the illuminated panel in a locker door. For example, the assembled illuminated insert assembly may be mounted within, on, or relative to a locker door, cabinet face, drawer panel, or other enclosure structure such that the illuminated indicia is visible from an exterior of the enclosure. In certain embodiments, step 516 includes electrically connecting the LED lighting assembly to a power source and activating the LED lighting assembly such that the acrylic insert emits visible light. Step 516 may further include connecting timers, dimmers, motion sensors, switches, or control circuitry to the LED lighting assembly to control operation of the illuminated panel.

In a preferred embodiment, method 500 includes additional steps or sub-steps associated with formation of the base panel and insert assembly. For example, step 502 may include routing both a primary opening and one or more recessed flange regions configured to receive a flange or retention structure associated with the acrylic insert. Step 504 may include aligning the interface panel relative to the routed opening such that the interface cavity defined by the interface panel substantially corresponds to the indicia shape of the acrylic insert. Step 506 may include inserting the acrylic insert into the opening such that an insert lip of the acrylic insert is received within a flange channel of a retention structure. Step 514 may include positioning the retaining frame over the insert assembly such that the retaining frame applies a retention force sufficient to maintain the layered stack in alignment.

In certain embodiments, the acrylic insert is formed by cutting, molding, machining, or otherwise shaping a light-transmissive panel material into a selected indicia configuration. The acrylic insert may be formed from acrylic sheet stock, polycarbonate sheet stock, glass, optical polymers, or combinations thereof. The acrylic insert may define letters, numbers, logos, symbols, or other indicia shapes.

In certain embodiments, method 500 further includes applying textures, patterns, coatings, or graphic treatments to one or more surfaces of the acrylic insert or colored insert layer. For example, a surface of the acrylic insert may be etched, engraved, patterned, printed, or coated to influence light extraction or visual appearance of the illuminated indicia.

In certain embodiments, step 512 includes positioning multiple lighting elements along different portions of the perimeter of the acrylic insert. Edge lighting elements may be positioned along opposed edges, adjacent edges, or substantially the entire perimeter of the acrylic insert to improve illumination uniformity across the indicia.

Although illustrated with a particular sequence of steps, method 500 is not limited to the exact order shown in FIG. 18. In certain embodiments, one or more steps may be performed in a different order, combined, omitted, or supplemented with additional steps depending on the desired panel construction. For example, the colored insert layer and diffuser layer may be positioned before or after installation of the acrylic insert relative to the base panel. Similarly, portions of the LED lighting assembly may be installed before or after positioning of the retaining frame.

In sum, the disclosed system includes an illuminated door assembly in which a layered insert structure cooperates with a perimeter lighting assembly to produce controlled illumination of indicia integrated within a locker door or enclosure panel. A base panel defines an opening configured to receive an insert assembly, and an interface panel positioned relative to the base panel establishes a visible boundary surrounding the illuminated indicia region. A shaped acrylic insert is positioned within the opening and cooperates with one or more additional layers including a colored indicia layer and a diffuser layer to form a multi-layer insert stack. A lighting assembly positioned along one or more perimeter edges of the acrylic insert introduces light into the insert, and the diffuser layer distributes the emitted light across the indicia region to produce a visually uniform illuminated appearance. A retaining frame captures and maintains the layered insert structure in a fixed positional relationship relative to the base panel and interface panel, while electrical coupling supplies power to the lighting assembly. Through this coordinated interaction of structural, optical, and electrical elements, the assembly provides a durable illuminated indicia panel that can be integrated into a locker door or similar enclosure structure.

Collectively, these effects provide one or more technological improvements relative to conventional approaches.

It is apparent that an assembly with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A self-lit door in a locker, comprising:
a substrate panel comprising:
a top edge;
a side edge; and
an opening formed at a location relative to the top edge and the side edge;
wherein the top edge and the side edge are generally straight and are connected by a corner;
an interface panel disposed relative to the base panel and defining an interface cavity aligned with the opening;
an acrylic insert positioned within the opening and the interface cavity;
an edge light disposed relative to at least a portion of a perimeter of the acrylic insert; and
a retention structure configured to retain the acrylic insert.

2. The self-lit door of claim 1, further comprising:
indicia illuminated by the edge light, wherein the acrylic insert forms at least a portion of the indicia.

3. The self-lit door of claim 2, wherein the indicia further comprises:
a colored insert layer positioned relative to the acrylic insert.

4. The self-lit door of claim 1, further comprising:
a diffuser layer positioned relative to the acrylic insert, wherein the diffuser layer is configured to distribute light emitted from the edge light across the acrylic insert.

5. The self-lit door of claim 4, wherein the edge light comprises:
a flexible LED strip light attached around at least a portion of a perimeter of the acrylic insert.

6. The self-lit door of claim 5, further comprising:
a retaining frame structured to frame the flexible LED strip light and at least one of the acrylic insert and the interface panel.

7. The self-lit door of claim 6, further comprising:
a power source connected to the edge light;
wherein the acrylic insert forms an illuminated indicia.

8. A self-lit door in a locker, comprising:
a base panel comprising:
a top edge;
a side edge; and
an opening formed at a location relative to the top edge and the side edge;
an interface panel positioned relative to the base panel and defining an interface cavity aligned with the opening;
an acrylic insert disposed within the opening and the interface cavity;
a lighting assembly disposed relative to at least a portion of a perimeter of the acrylic insert; and
a retaining frame.

9. The self-lit door of claim 8, further comprising:
indicia illuminated by the lighting assembly.

10. The self-lit door of claim 9, wherein the indicia comprises:
a colored indicia layer disposed relative to the acrylic insert.

11. The self-lit door of claim 8, further comprising:
a diffuser layer positioned relative to the acrylic insert and configured to distribute light emitted from the lighting assembly across the acrylic insert.

12. The self-lit door of claim 11, wherein the lighting assembly comprises:
a flexible LED strip light disposed along at least a portion of a perimeter of the acrylic insert.

13. The self-lit door of claim 12, wherein the retaining frame comprises:
a metal perimeter framing at least one of the acrylic insert and the flexible LED strip light.

14. The self-lit door of claim 13, further comprising:
a power source in electrical communication with the flexible LED strip light;
wherein the acrylic insert forms an illuminated indicia panel.

15. A method for illuminating indicia of a self-lit locker, comprising:
forming a base panel of the self-lit locker having:
a top edge;
a side edge; and
an opening formed at a location relative to the top edge and the side edge;
positioning an interface panel relative to the base panel such that an interface cavity is aligned with the opening;
positioning a light-transmissive insert within the opening and the interface cavity;
positioning a lighting assembly relative to at least a portion of a perimeter of the light-transmissive insert; and
applying a retention structure configured to retain the light-transmissive insert relative to at least one of the base panel and the interface panel.

16. The method of claim 15, further comprising:
connecting a power source to the lighting assembly;
wherein the lighting assembly comprises a flexible LED light strip.

17. The method of claim 15, further comprising:
positioning a colored indicia layer relative to the light-transmissive insert;
wherein the light transmissive insert is formed in a shape corresponding to an indicia.

18. The method of claim 17, further comprising:
positioning a diffuser layer relative to the light-transmissive insert;
wherein the diffuser layer is configured to distribute light emitted from the lighting assembly across the indicia.

19. The method of claim 17, further comprising:
securing at least one of the light-transmissive insert and the interface panel with a retaining frame.

20. The method of claim 19, wherein the securing at least one of the light-transmissive insert comprises:
framing the light-transmissive insert with a perimeter frame and positioning the perimeter frame relative to the base panel;
installing the illuminated indicia panel within a locker door.
